(19) United States
(12) Patent Application Publication
(10) Pub. No.: US 2014/0285168 A1
(43) Pub. Date: Sep. 25, 2014

(54) ADJUSTABLE VOLTAGE OUTPUT DEVICE AND ADJUSTMENT METHOD OF OPERATING VOLTAGE

(71) Applicants: INVENTEC CORPORATION, Taipei (TW); Inventec (Pudong) Technology Corporation, Shanghai (CN)

(72) Inventor: Sheng-Lung CHIH, Taipei (TW)

(73) Assignees: INVENTEC CORPORATION, Taipei (TW); Inventec (Pudong) Technology Corporation, Shanghai (CN)

(21) Appl. No.: 14/219,858

(22) Filed: Mar. 19, 2014

(30) Foreign Application Priority Data
Mar. 20, 2013 (CN) 201310090822.9

(51) Int. Cl. H02M 3/156

(52) U.S. Cl. CPC H02M 3/156
USPC 323/282

(57) ABSTRACT

This disclosure relates to an adjustable voltage output device and an adjustment method of an operating voltage, in which the adjustable voltage output device utilizes a basic input/output system for adjusting the duty cycle of the pulse width modulation (PWM) signal outputted by the PWM signal generation unit, so as to change the operating voltage outputted by the voltage generation unit.

### CROSS-REFERENCE TO RELATED APPLICATIONS

This non-provisional application claims priority under 35 U.S.C. §119(a) on Patent Application No(s). 201310090822.9 filed in China on Mar. 20, 2013, the entire contents of which are hereby incorporated by reference.

### BACKGROUND OF THE INVENTION

1. Technical Field of the Invention

This disclosure relates to an adjustable voltage output device and an adjustment method of an operating voltage, in particular an adjustable voltage output device and an adjustment method of the operating voltage, where the operating voltage is adjusted via a basic input/output system.

2. Description of the Related Art

With the advancement of technology, electronic products with various functions have been developed. Electronic products usually include a variety of integrated circuits and different loads that require different operating voltages. Therefore, electronic products are usually equipped with a power converter, to convert a fixed-level voltage into the required operating voltage of each integrated circuit.

The power converter is a voltage conversion circuit with inductors and capacitors that charge interactively. The power converter can be of a plurality of architectures, such as boost, buck, inverting and transformer flyback architectures.

Nowadays, power converters are widely used in a variety of electronic products, such as portable electronic products, computer products and so on. A pulse width modulation (PWM) controller is a method to control a continuous time mode power converter. As known by those skilled in this art, the PWM controller can generate a PWM signal to control a transistor coupled to the output end of the power converter. A duty cycle of the PWM signal is used to control the switching statuses (i.e., conducting or non-conducting) of the transistor, so that the power converter is maintained within a specified voltage range. For example, when the load of the power converter increases, the PWM controller will increase the duty cycle of the PWM signal. Conversely, when the load decreases, the PWM controller will reduce the duty cycle of the PWM signal.

To comply with the frequent update of new hardware specifications, motherboard applications generally have power conversion ICs added, or have their hardware circuit redesigned to adjust the duty cycle of the PWM signal. However, doing so will cause a substantial increase of chip area or a rise in manufacture cost.

### SUMMARY OF THE INVENTION

This invention provides an adjustable voltage output device, for supplying the operating voltages required to operate a load device. The adjustable voltage output device includes a voltage generation unit, a basic input/output system and a pulse width modulation (PWM) signal generation unit. The voltage generation unit generates an operating voltage based on the PWM signal. The basic input/output system (BIOS) detects a required operating voltage of the load device, and judges whether the current operating voltage generated by the voltage generation unit is the same as the detected required operating voltage of the load device or not. The PWM signal generation unit is coupled to the BIOS and the voltage generation unit to generate a PWM signal. If the current operating voltage generated by the voltage generation unit is not the same as the detected required operating voltage of the load device, the BIOS will control the PWM signal generation unit to adjust the duty cycle of the PWM signal, thus adjusting the operating voltage.

In one of the embodiments of this invention, the chip set includes a second temporary storage unit, for temporarily storing the operation voltage information indicated by the BIOS.

In one of the embodiments of this invention, the BIOS includes a first temporary storage unit, for temporarily storing the information regarding the required operating voltage of the load device.

This invention provides an adjustment method of an operating voltage, which supplies the required operation voltage of the load device. The adjustable voltage output device includes a voltage generation unit, a basic input/output system (BIOS) and a pulse width modulation (PWM) signal generation unit. The adjustment method of the operating voltage includes the following steps. The BIOS detects the required operating voltage of the load device. The BIOS judges whether the current operating voltage generated by the voltage generation unit is the same as the detected required operating voltage of the load device. If the current operating voltage generated by the voltage generation unit is not the same as the detected required operating voltage of the load device, the PWM signal generation unit adjusts the duty cycle of the PWM signal it outputs. The operating voltage is then generated according to the PWM signal in the output step.

In some embodiments, the step that the BIOS adjusts the duty cycle of the PWM signal outputted by the PWM signal generation unit includes: temporarily storing the operating voltage information indicated by the BIOS, on the PWM signal generation unit.

In some embodiments, the adjustment method of the operating voltage further includes: temporarily storing information regarding the required operating voltage of the load device on the BIOS.

In some embodiments of this invention, the PWM signal generation unit includes a chip set or an embedded controller.

In order to make the above features and benefits more obvious and understandable, the following gives some examples, accompanied with drawings for further detailed description.

### BRIEF DESCRIPTION OF THE DRAWINGS

The present disclosure will become more fully understood from the detailed description given herein below for illustration only, and thus does not limit the present disclosure, wherein:

FIG. 1 is a schematic diagram of an adjustable voltage output device according to one embodiment.

FIG. 2 is a schematic diagram of an adjustable voltage output device according to one embodiment.

FIG. 3 is a flow chart of the adjustment method of the operating voltage for the adjustable voltage output device according to one embodiment.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

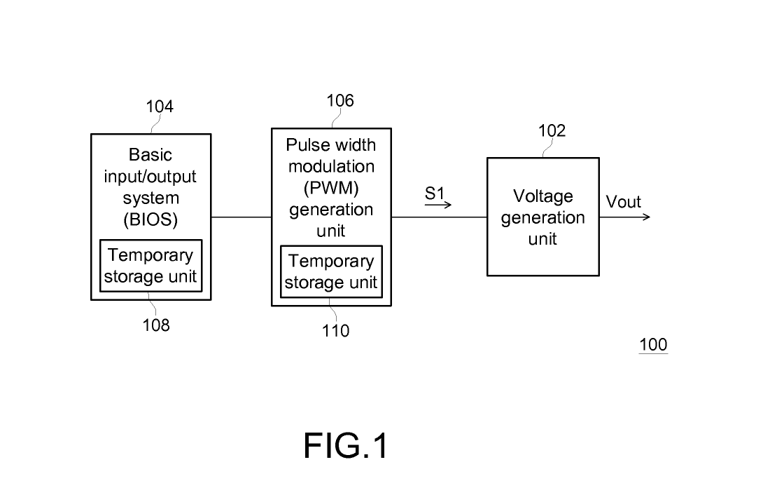

FIG. 1 is a schematic diagram of an adjustable voltage output device according to one of the embodiments of this invention. In FIG. 1, the adjustable voltage output device 100 includes a voltage generation unit 102, a basic input/output system (BIOS) 104 and a pulse width modulation (PWM) signal generation unit 106. The PWM signal generation unit 106 is coupled between the voltage generation unit 102 and the BIOS 104, and the PWM signal generation unit 106 is, for example, a chip set or an embedded controller.

The adjustable voltage output device 100 is configured to supply a required operating voltage of a load device (not shown) connected to the adjustable voltage output device 100. The voltage generation unit 102 is configured to generate an operating voltage Vout based on a PWM signal S1. The PWM signal generation unit 106 is configured to generate the PWM signal S1. The BIOS 104 is configured to detect the required operating voltage of the load device, and judge whether the current operating voltage Vout generated by the voltage generation unit 102 is the same as the detected required operating voltage of the load device or not.

When the BIOS 104 determines that the current operating voltage Vout generated by the voltage generation unit 102 is the same as the detected required operating voltage of the load device, the BIOS 104 will not control the PWM signal generation unit 106 to adjust the duty cycle of the PWM signal S1, while making the voltage generation unit 102 continue to output the operating voltage Vout to the load device according to the PWM signal S1 currently generated by the PWM signal generation unit 106.

When the BIOS 104 determines that the current operating voltage Vout generated by the voltage generation unit 102 is not the same as the detected required operating voltage of the load device, the BIOS 104 will control the PWM signal generation unit 106 to adjust the duty cycle of the PWM signal S1, so that the voltage generation unit 102 generates the operating voltage Vout based on the PWM signal S1 after the adjustment of the duty cycle, thus adjusting the value of the operating voltage Vout to the required operating voltage of the load device.

Furthermore, the BIOS 104 and the PWM signal generation unit 106 can respectively include a first temporary storage unit 108 and a second temporary storage unit 110, and the BIOS 104 can store the detected operating voltage information, required for the operation of the load device, on the temporary storage unit 108.

When the BIOS 104 determines that the current operating voltage Vout generated by the voltage generation unit 102 is not the same as the detected operating voltage of the load device, the operating voltage information stored on the temporary storage unit 108 will be transmitted to the temporary storage unit 110 of the PWM signal generation unit 106, so that the PWM signal generation unit 106 can adjust the duty cycle of the PWM signal S1 based on the operating voltage information stored on the temporary storage unit 110 of the PWM signal generation unit 106.

For example, if the load device connected to the adjustable voltage output device 100 is a memory device DDR so-dimm, usually having an Electrically-Erasable Programmable Read Only Memory (EEPROM) thereon, configured to store the relevant information of DDR so-dimm, such as which type of DDR so-dimm memory device (DDR 3L or DDR 3) it is.

When a computer system is booted, the BIOS 104 reads the relevant information of the DDR so-dimm memory device stored on the EEPROM to obtain the operating voltage of the DDR so-dimm memory device, and to judge whether the current operating voltage Vout generated by the voltage generation unit 102 complies with the required operating voltage of the DDR so-dimm memory device. If the two voltages are different, the duty cycle of the PWM signal S1 is reconfigured, adjusting the operating voltage Vout to the required operating voltage of the DDR so-dimm memory device.

For example, if the operating voltage Vout generated by the voltage generation unit 102 is 1.5V by default, while the required operating voltage of the DDR so-dimm memory device is 1.35V, the BIOS will perform a restart to adjust the operating voltage Vout outputted by the voltage generation unit 102 (to 1.35V).

The general chip sets or embedded controllers have spare PWM signals not assigned to be used otherwise. The embodiments allows the adjustable voltage output device to use one of the spare PWM signals of the chip sets or embedded controllers, thus eliminating the need for an additional circuit for generating the additional PWM signal S1. Also, the BIOS 104 is used for detecting the required operating voltage of the load device, and adjusting the duty cycle of the PWM signal S1 outputted by the PWM signal generation unit 106. Doing so can greatly reduce the manufacture cost of the electronic device using the adjustable voltage output device, as a simple modification of the programming code in the BIOS 104 can replace the necessity to re-design the hardware circuit.

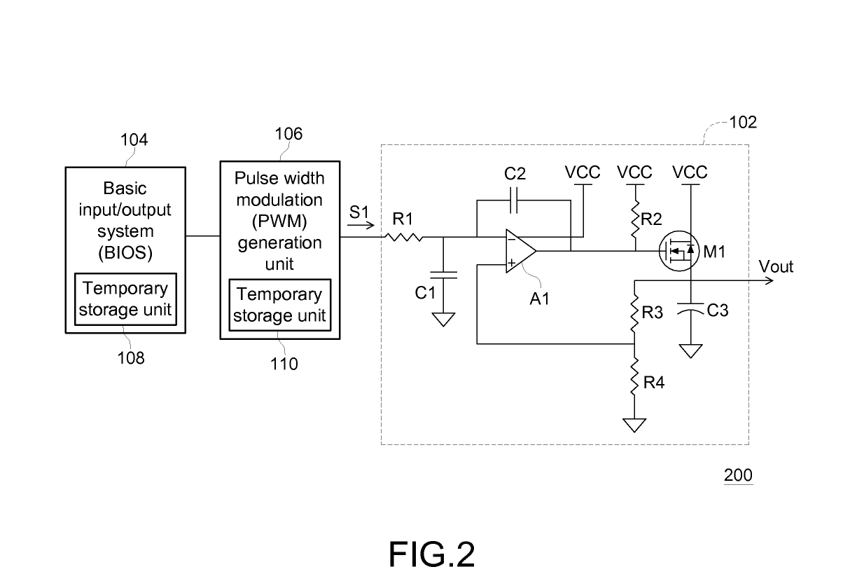

In addition, the voltage generation unit 102 is, for example, a low-dropout (LDO) or AC/DC power converter and other power converters that perform voltage conversion based on the PWM signal. For example, FIG. 2 is a schematic diagram of an adjustable voltage output device according to another embodiment. In this embodiment, the voltage generation unit 102 is a LDO. It should be noted that, the voltage generation unit 102 of this embodiment is just an exemplary embodiment, and the invention should not be limited to this.

In this embodiment, the voltage generation unit 102 of the adjustable voltage output device 200 includes an operational amplifier A1, capacitors C1-C3, resistors R1-R4 and a power transistor M1. The resistor R1 is coupled between the PWM signal generation unit 106 and the negative input end of the operational amplifier A1; the capacitor C1 is coupled between the positive input end of the operational amplifier A1 and ground; the capacitor C2 is coupled between the negative input end and the output end of the operational amplifier A1; and the operational amplifier A1 is coupled to the supply voltage VCC to receive the voltage required for the operation.

The resistor R2 is coupled between the gate of the power transistor M1 and the supply voltage VCC; the gate of the power transistor M1 is coupled to the output end of the operational amplifier A1; the drain of the power transistor M1 is coupled to the supply voltage VCC; and the source of the power transistor M1 is coupled to ground via the capacitor C3. In addition, the resistors R3 and R4 are connected in series between the source of the power transistor M1 and ground, and the common contact point between the resistors R3 and R4 is coupled to the positive input end of the operational amplifier A1.

As shown in the figure, the PWM signal S1 from the PWM signal generation unit 106 is integrated via an integrating circuit consisting of the operational amplifier A1, the resistor R1 and the capacitors C1 and C2. The resultant integrated signal then controls the on/off of the power transistor M1, so as to generate the operating voltage Vout at the source of the power transistor M1. Therefore, the BIOS 104 controls the PWM signal generation unit 106 to adjust the duty cycle of the PWM signal S1 generated by the unit itself, thus changing the value of the operating voltage Vout, so as to comply with the required operating voltage of the load device (not shown) that is coupled to the adjustable voltage output device 200.

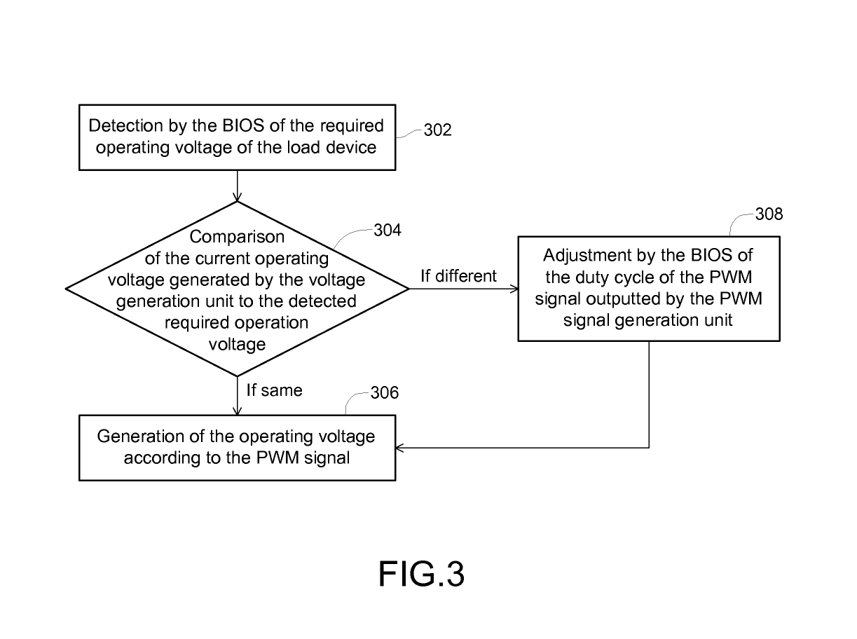

FIG. 3 is a flow chart of the adjustment method of the operating voltage for the adjustable voltage output device according to one of the embodiments of this invention. FIG. 3 shows the steps of the adjustment method of the operating voltage for the adjustable voltage output device, which are described here. Firstly, the BIOS detects the required operating voltage of the load device (step 302).

In some embodiments, the detected information regarding the required operating voltage of the load device is stored in the temporary storage unit of the BIOS. After that, the BIOS judges whether the current operating voltage outputted by the adjustable voltage output device is the same as the required operating voltage of the load device (step 304).

If the current operating voltage outputted by the adjustable voltage output device is the same as the detected required operating voltage of the load device, the duty cycle of the PWM signal outputted by the PWM signal generation unit will not be changed; thus generating the operating voltage based on the PWM signal outputted by the PWM signal generation unit (step 306).

Conversely, if the current operating voltage outputted by the adjustable voltage output device differs from the detected required operating voltage of the load device, the BIOS adjusts the duty cycle of the PWM signal outputted by the PWM signal generation unit (step 308).

In some embodiments, the required operating voltage of the load device can be stored in the temporary storage unit of the PWM signal generation unit (e.g., chip set or embedded controller), so that the chip set or embedded controller can generate the PWM signal through an adjustment of the duty cycle according to the operating voltage information, after rebooting the computer system that uses the adjustable voltage output device. After adjusting the duty cycle of the PWM signal, step S306 can be performed, i.e., generating the operating voltage based on the PWM signal.

The spare PWM signal of the chip sets or embedded controllers can be used in this adjustable voltage output device to eliminate the need for an additional circuit for generating the additional PWM signal. The BIOS is used for detecting the required operating voltage of the load device, and adjusting the duty cycle of the PWM signal outputted by the PWM signal generation unit. Doing so can greatly reduce the manufacture cost of the electronic device using the adjustable voltage output device, as a simple modification of the programming code in the BIOS can replace the necessity to re-design the hardware circuit.

What is claimed is:

1. An adjustable voltage output device, for supplying a required operating voltage of a load device, the adjustable voltage output device comprising:
a voltage generation unit, configured to generate an operating voltage based on a pulse width modulation (PWM) signal;
a basic input/output system (BIOS), configured to detect the required operating voltage of the load device, and judge whether the current operating voltage generated by the voltage generation unit is the same as the detected required operation voltage of the load device; and
a PWM signal generation unit, coupled to the BIOS and the voltage generation unit to generate a PWM signal; wherein, if the current operating voltage generated by the voltage generation unit is not the same as the detected required operating voltage of the load device, the BIOS controls the PWM signal generation unit to adjust the duty cycle of the PWM signal, thus adjusting the operating voltage.

2. The adjustable voltage output device according to claim 1, wherein the PWM signal generation unit is a chip set or an embedded controller.

3. The adjustable voltage output device according to claim 1, wherein the BIOS includes:
a first temporary storage unit, configured to temporarily store the information about the required operating voltage of the load device.

4. The adjustable voltage output device according to claim 1, wherein the PWM signal generation unit comprises:
a second temporary storage unit, configured to temporarily store the operating voltage information indicated by the BIOS.

5. An adjustment method of an operating voltage supplied by an adjustable voltage output device, for supplying a required operating voltage of a load device of the adjustable voltage output device; the adjustable voltage output device comprising: a basic input/output system (BIOS) and a pulse width modulation (PWM) signal generation unit, the adjustment method of the operating voltage comprising:
detecting, by the BIOS, the required operating voltage of the load device;
judging, by the BIOS, whether the current operating voltage generated by the voltage generation unit is the same as the detected voltage for the operation of the load device or not;
if the current operating voltage generated by the voltage generation unit is not the same as the detected voltage for the operation of the load device, adjusting, by the BIOS, the duty cycle of the PWM signal outputted by the PWM signal generation unit; and
generating the operating voltage according to the PWM signal.

6. The adjustment method of the operating voltage according to claim 5, wherein the PWM signal generation unit is a chip set or an embedded controller.

7. The adjustment method of the operating voltage according to claim 5, wherein the step of adjusting, by the BIOS, the duty cycle of the PWM signal outputted by the PWM signal generation unit comprises:
temporarily storing the operating voltage information indicated by the BIOS, in the PWM signal generation unit.

8. The adjustment method of the operating voltage according to claim 5, wherein the adjustment method further comprises:
temporarily storing in the BIOS the information about the required operating voltage of the load device.
